(19) United States
(12) Patent Application Publication
(10) Pub. No.: US 2012/0000721 A1
(43) Pub. Date: Jan. 5, 2012

(54) AFTERMARKET ELECTRICAL PROPULSION SYSTEM FOR VEHICLES

(75) Inventor: Frank F. Lipski, Artesia, CA (US)

(73) Assignee: FAZER TECHNOLOGIES CORPORATION, Lake Forest, CA (US)

(21) Appl. No.: 12/827,067

(22) Filed: Jun. 30, 2010

(51) Int. Cl. B60K 6/42; B60K 7/00

(52) U.S. Cl. 180/65.22; 180/65.21

(57) ABSTRACT

A supplemental propulsion system for a vehicle includes an electrical generator coupled to the vehicle's engine. At least one electric motor is coupled to one or more propulsion devices, such as road wheels of a motor vehicle. Electrical power from the generator is supplied to an electronic control unit that then supplies electric power to the electric motor. The system may be configured to be retrofitted to a conventional gasoline or diesel-powered vehicle.

### BACKGROUND OF THE INVENTION

1. Field of the Invention

The present invention relates generally to the field of vehicle propulsion systems and, more particularly, to an electrical propulsion system that may be easily retrofitted to a conventional gasoline or diesel-powered vehicle.

2. Background

There is widespread concern about the continued use of fossil fuels to provide power for automobiles and other vehicles. Numerous alternative energy sources have been proposed. One alternative that has met with considerable success is the “hybrid” vehicle that uses a conventional gasoline engine to mechanically power the vehicle's wheels and to also generate electrical power for one or more electric motors. Hybrid vehicles have a relatively large array of batteries to store electrical power so that they can operate for extended periods using only the electric motors. If additional power is required, as when the vehicle is under heavy load or when the batteries are discharged, traditional vehicle propulsion is provided by the gasoline engine.

Hybrid vehicles and other alternative energy vehicles are built from the outset with their respective power trains. To date, there has been no practical system for converting a conventional gasoline or diesel-powered vehicle to utilize electrical power for propulsion.

### SUMMARY OF THE INVENTION

Embodiments of the present invention provide a supplemental propulsion system for a vehicle that can be retrofitted to a conventional gasoline or diesel-powered vehicle. The system includes an electrical generator coupled to the vehicle's engine. At least one electric motor is coupled to one or more road wheels. Electrical power from the generator is supplied to an electronic control unit (ECU) that then supplies electric power to the electric motor.

In a certain specific embodiment, a supplemental propulsion system is adapted for use with a conventional front-wheel drive automobile. An electrical generator is coupled to the vehicle's engine and the ECU is installed in a convenient location. The rear wheels of the vehicle, which are unpowered in a conventional front-wheel drive vehicle, are powered by electric motors. The motors may be installed inboard of the rear wheels with an appropriate mechanical drive mechanism coupled to the stock vehicle wheels. Alternatively, the motors may be installed integrally with the vehicle's rear wheels.

Other embodiments of the invention are adapted for use with other types of vehicles, including trucks, buses, motor homes, motorcycles, rail vehicles, aircraft and watercraft.

### BRIEF DESCRIPTION OF THE DRAWINGS

FIG. 1 illustrates the principal components of a supplemental propulsion system in accordance with an embodiment of the present invention.

FIG. 2 is a functional block diagram of the electronic control unit of FIG. 1.

FIG. 3 illustrates installation of a supplemental propulsion system in a conventional front-wheel drive vehicle.

FIG. 4 illustrates an embodiment of the present invention having a supplemental drive wheel that is detachably coupled to an automobile.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

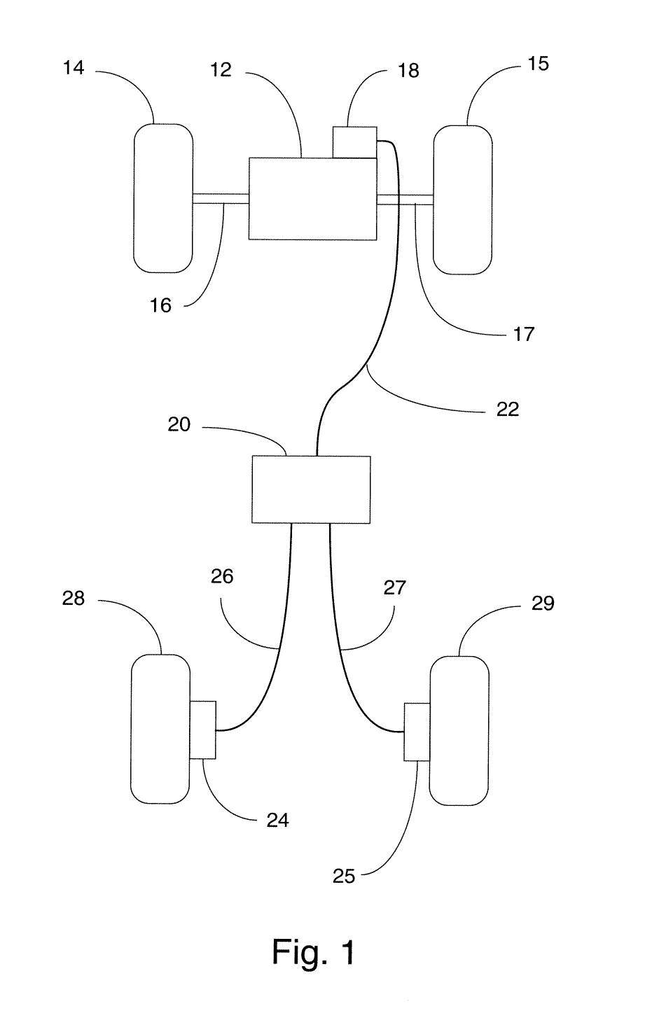

FIG. 1 diagrammatically illustrates a supplemental vehicle propulsion system in accordance with one embodiment of the present invention. This embodiment is applied to a conventional gasoline or diesel-powered front-wheel drive automobile. The automobile has an engine and transmission unit 12 that drives front wheels 14 and 15 through mechanical couplings 16 and 17. A generator 18 is coupled to the vehicle engine to convert rotational energy of the engine into electrical power. The generator may be coupled to an output shaft of the vehicle engine with a belt and pulley arrangement of the type commonly used to power automotive engine accessories or by another suitable mechanical drive system. Generator 18 may be an axial gap electrical induction generator of the type disclosed in U.S. Pat. No. 5,734,217. A commercial version of such a generator is marketed as the AuraGen Induction Power Source by Aura Systems Inc. of El Segundo, Calif., for use in generating electrical power for tools, appliances and the like. One model of such a generator is capable of producing 8 kilowatts of continuous AC power while consuming approximately 13.4 hp from the vehicle engine and 9 kilowatts peak power.

Electrical energy produced by generator 18 is delivered to electronic control unit (ECU) 20 on bus 22. Electrical power from ECU 20 is delivered to electric motors 24 and 25 on buses 26 and 27, respectively. Motors 24 and 25 are coupled to drive wheels 28 and 29, respectively.

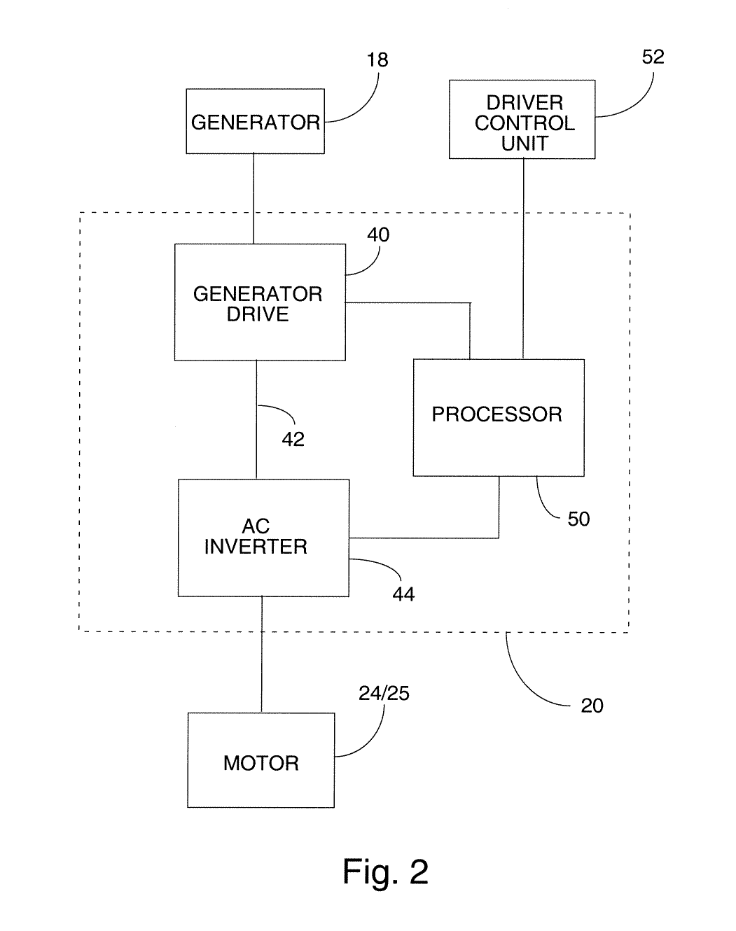

The ECU 20 is configured to operate with the particular characteristics of generator 18 and motors 24 and 25. In one embodiment, ECU 20 may be of the type disclosed in U.S. Pat. No. 6,700,214. With reference to FIG. 2, ECU 20 includes a generator drive circuit 40 coupled to the generator 18 to generate power for a DC power supply bus 42 connected to an AC inverter 44.

The generator drive 40 is responsive to the amplitude- and frequency-variant signal produced by the generator 18 and is controlled by a processor 50 to maintain the DC power supply bus 42 at a desired DC voltage level. The AC inverter 44 produces AC output power by converting the DC voltage supplied by the power bus 42 into an AC power signal.

When the vehicle engine is running and the generator 18 is generating electrical power, the generator drive 40 attempts to regulate the electrical power produced by the generator such that a desired voltage level across the power supply bus 42 is achieved. The generator drive 40, responsive to control signals received from the processor 50, attempts to regulate the electrical power produced by the generator 18 such that the DC power bus 42 is maintained at a constant nominal voltage. The AC inverter 44 converts the DC power into a plurality of AC output power signals, such as for example, two 120 VAC, 60 Hz signals, 180° out of phase. The AC inverter 44 supplies the plurality of output AC power signals to the AC load, i.e., motors 24 and 25.

The ECU may be configured to automatically activate the AC inverter 44 to produce AC power immediately upon start-up of the vehicle engine. At initial start-up of the system, there exists no voltage on the DC power supply bus 42. In the described embodiment, the generator 18 is an induction-type generator and lacks self-excitation. The lack of DC voltage on the power supply bus 42 precludes the generator drive 40 from developing or applying any current for the generator stator field coils. Thus, shortly after initial start-up, the system draws electrical power from the vehicle battery (not shown) to the generator drive 40 to enable the generator drive to apply sufficient current to drive the generator. Once the generator drive 40 has been supplied with adequate power, the generator drive develops a current for the generator stator field coil windings. The electrical power generated by the generator 18 then charges the power supply bus 42. When the voltage of the power supply bus 42 is sufficient for the generator drive 40 to develop current for the generator stator field coils, the system may disable the flow of electrical power from the vehicle battery.

A driver control unit 52 is coupled to processor 50 and is located on the dashboard of the vehicle or otherwise within reach of the driver. Control unit 52 allows the driver to activate the supplemental propulsion system and to manually control its output. In a manner similar to a conventional cruise control device, the driver can regulate the supplemental propulsion system to set the vehicle speed, to accelerate, to coast or to resume a previously set speed. Under most driving conditions, the vehicle's gasoline or diesel-powered engine need only be idling to supply sufficient electrical power to the electric drive motors.

Motors 24 and 25 may be mounted inboard of drive wheels 28 and 29 and drive the wheels through suitable mechanical couplings. Alternatively, motors may be mounted integrally with the drive wheels. In a further alternative, the electric motors may be motor/generators so that kinetic energy of the vehicle may be captured and stored as electrical energy. Thus when the vehicle is not being powered by the electric motors, such as when the vehicle is coasting or braking, the motor/generators are mechanically driven by their respective road wheels and act as electrical generators to deliver electrical energy to a battery or other suitable storage device.

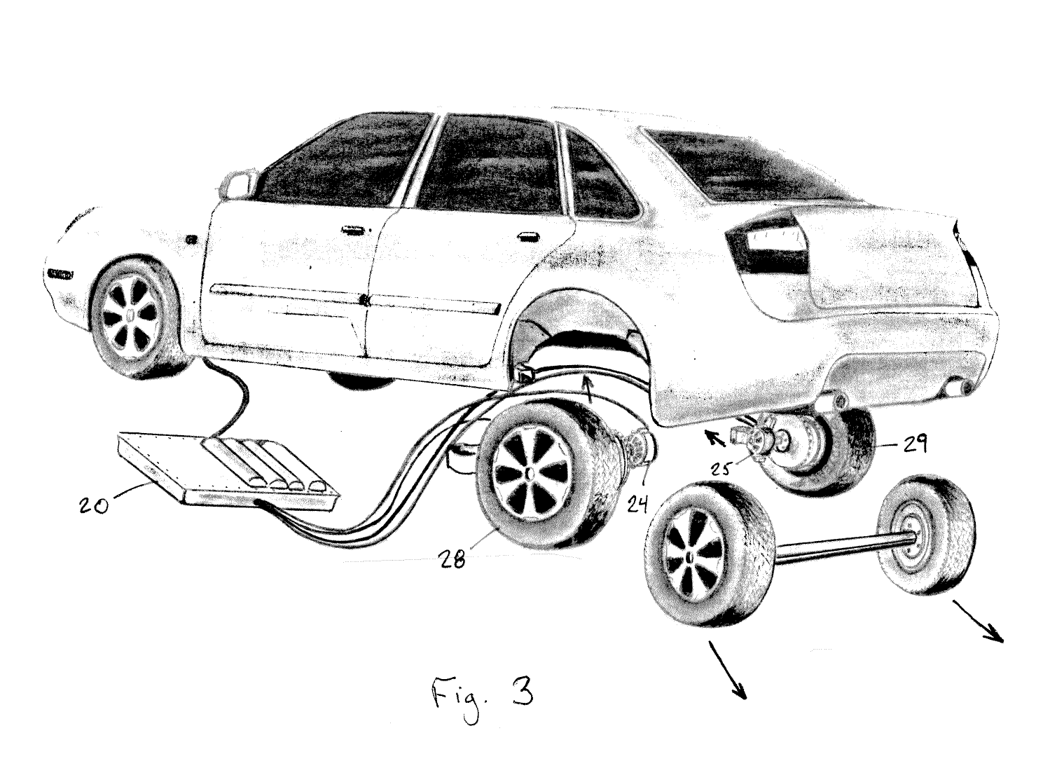

FIG. 3 illustrates the installation of a supplemental propulsion system in a conventional front-wheel drive automobile. As previously discussed, a generator 18 (not shown here) is coupled to the automobile's gasoline or diesel engine. ECU 20 is mounted in a suitable location in or under the automobile. The conventional rear axle of the automobile is replaced with motors 24,25 and suitable mechanical couplings as noted above. The stock wheels 28 and 29 may be retained.

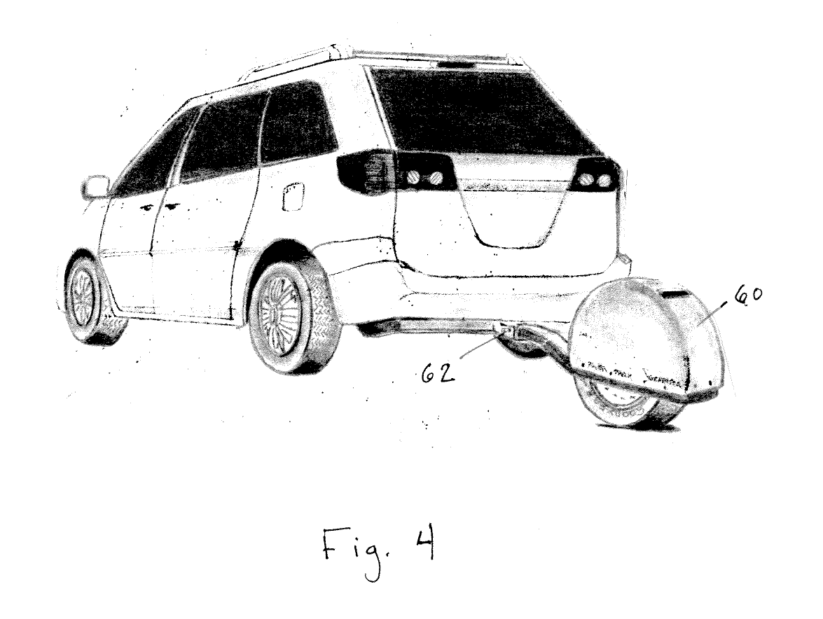

FIG. 4 illustrates another embodiment of the present invention. Here, the electric motor and its associated drive wheel are disposed in a separate unit 60 that is attached behind a vehicle. Such attachment may be made using a conventional trailer hitch 62. The supplemental propulsion unit may be configured with one or more electric motors and with one or more drive wheels. Furthermore, two or more single wheel/single drive wheel units may be attached side-by-side behind the vehicle. The ECU may be mounted in or under the vehicle as previously described or may be included in the supplemental propulsion unit 60. In any case, the engine-driven generator is coupled to the vehicle's engine as in the previously described embodiments.

Although the invention has been described in connection with certain embodiments for use with an automobile, it will be recognized that the invention also finds application to any type of motorized vehicle, including, without limitation, trucks, buses, motor homes, motorcycles, locomotives and other rail vehicles, aircraft and watercraft.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A supplemental propulsion system for a vehicle comprising:
an electrical generator coupled to a vehicle engine, the vehicle engine mechanically coupled to a first vehicle propulsion device;
a motor coupled to a second vehicle propulsion device;
an electronic control unit coupled to the generator and to the motor to supply electrical power from the generator to the motor.

2. The supplemental propulsion system of claim 1 wherein the motor is coupled to a second propulsion device that is not otherwise coupled to the vehicle engine.

3. The supplemental propulsion system of claim 2 wherein the second propulsion device is a vehicle wheel.

4. The supplemental propulsion system of claim 1 wherein the vehicle is an automobile.

5. The supplemental propulsion system of claim 1 wherein the vehicle is a truck.

6. The supplemental propulsion system of claim 1 wherein the vehicle is a bus.

7. The supplemental propulsion system of claim 1 wherein the vehicle is a motor home.

8. The supplemental propulsion system of claim 1 wherein the vehicle is a motorcycle.

9. The supplemental propulsion system of claim 1 wherein the vehicle is a rail vehicle.

10. The supplemental propulsion system of claim 1 wherein the vehicle is an aircraft.

11. The supplemental propulsion system of claim 1 wherein the vehicle is a watercraft.

12. A supplemental propulsion system for an automobile comprising:
an electrical generator coupled to an automobile engine, the automobile engine mechanically coupled to first and second drive wheels;
at least one motor coupled to a third drive wheel separate from the first and second drive wheels;
an electronic control unit coupled to the generator and to said at least one motor to supply electrical power from the generator to said at least one motor.

13. The supplemental propulsion system of claim 12 wherein said at least one motor is one of a pair of motors coupled respectively to third and fourth drive wheels.

14. The supplemental propulsion system of claim 13 wherein the first and second drive wheels are front wheels of the automobile and the third and fourth drive wheel are rear wheels of the automobile.

15. The supplemental propulsion system of claim 12 wherein said at least one motor and third drive wheel are disposed in a unit detachably coupled to the automobile.
